(19) United States
(12) Patent Application Publication
(10) Pub. No.: US 2017/0163302 A1
(43) Pub. Date: Jun. 8, 2017

(54) HEAT TRANSFER ELECTROMAGNETIC INTERFERENCE SHIELD

(71) Applicant: QUALCOMM Incorporated, San Diego, CA (US)

(72) Inventors: Mehdi SAEIDI, San Diego, CA (US); Emil RAHIM, San Diego, CA (US); Rajat MITTAL, San Diego, CA (US); Arpit MITTAL, San Diego, CA (US)

(21) Appl. No.: 14/957,569

(22) Filed: Dec. 2, 2015

(51) Int. Cl. H04B 1/3827

(52) U.S. Cl. CPC H04B 1/3838; H04B 1/385

(57) ABSTRACT

A method and an apparatus for providing thermal solution are provided. The apparatus includes an electronic component that emits heat during the operation of the apparatus. A single-piece component covers the electronic component and is configured to shield the electronic component from an electromagnetic field surrounding the electronic component. The single-piece component is also configured to transfer at least a portion of the heat emitted by the electronic component to a cooling region of the apparatus. In another aspect, a method and an apparatus for providing thermal solution are provided. The apparatus shields an electronic component of the apparatus from an electromagnetic field surrounding the electronic component. The apparatus transfers at least a portion of heat emitted by the electronic component to a cooling region of the mobile device. The shielding and the transferring are performed by the same single-piece component of the apparatus.

### BACKGROUND

Field

The present disclosure relates generally to thermal solution for electronic devices and systems, and more particularly, to thermal solution for mobile devices and systems.

Background

As mobile computing devices become more integrated and include more computing power, they may generate more heat. For example, a modern smart phone may include one or more highly integrated components known as a system on a chip (SoC) or a system in package (SiP). Each SoC or SiP may have one or more integrated circuits (ICs) with one or more processor cores, memory circuits, graphics processing circuits, radio frequency communication circuits, and other digital and analog circuits. Further, multiple SoCs or SiPs may be stacked in a package on package (PoP) configuration. A common PoP configuration includes one SoC or SiP package that has processing and other circuits, with a second stacked package that includes volatile and/or non-volatile memory components.

These highly integrated processing components may generate a large amount of heat within a tightly integrated packaging structure. Additionally, many manufacturers desire to increase the number of processing cores and processor clock speeds, further increasing the amount of heat generated in the package. For mobile computing device processors especially, heat may become a limiting factor to computing performance.

Mobile devices include wearable devices. Wearable devices, also known as wearable computers, are miniature electronic devices that can be worn by a person. An example of a wearable device is a smart watch, which is a computerized wristwatch with functionality that is enhanced beyond timekeeping. A smart watch may include features such as a camera, accelerometer, thermometer, altimeter, barometer, compass, chronograph, calculator, cell phone, touch screen, Global Positioning System (GPS) navigation, map display, graphical display, speaker, scheduler, watch, mass storage device, and rechargeable battery. It may communicate with a wireless headset, heads-up display, insulin pump, microphone, modem, or other devices.

Because of the increasing number of functionalities and improving computing power of wearable devices, an increased level of heat is emitted by these devices while performing functions. At the same time, wearable devices become smaller and smaller, thus making thermal management more and more difficult. Therefore, improved thermal solution for wearable devices is desirable.

### SUMMARY

In an aspect of the disclosure, a method and an apparatus for providing thermal solution are provided. The apparatus includes an electronic component that emits heat during the operation of the apparatus. The apparatus includes a single-piece component covering the electronic component. The single-piece component is configured to shield the electronic component from an electromagnetic field surrounding the electronic component. The single-piece component is also configured to transfer at least a portion of the heat emitted by the electronic component to a cooling region of the apparatus.

In another aspect of the disclosure, a method and an apparatus for providing thermal solution are provided. The apparatus shields an electronic component of the apparatus from an electromagnetic field surrounding the electronic component. The apparatus transfers at least a portion of heat emitted by the electronic component to a cooling region of the mobile device. The shielding and the transferring are performed by the same single-piece component of the apparatus.

### BRIEF DESCRIPTION OF THE DRAWINGS

FIG. 1 is a diagram illustrating an example of a cross section side view of parts of a mobile device.

FIG. 2 is a diagram illustrating an example of a cross section side view of parts of a mobile device.

FIG. 3 is a diagram illustrating an example of a manufacturing process for a single-piece hybrid component that integrates EMI shield and heat pipe.

FIG. 4 is a diagram illustrating an example of a manufacturing process for a single-piece hybrid component that integrates EMI shield and vapor chamber.

FIG. 5 is a diagram illustrating an example of a manufacturing process for a single-piece hybrid component of a mobile device that transfers heat from a hot region of the mobile device to a cold region of the mobile device.

FIG. 6 is a diagram illustrating an example of a top view of parts of a mobile device that includes a single-piece hybrid component.

FIG. 7 is a flowchart of a method of providing a thermal solution for a mobile device.

FIG. 8 is a diagram illustrating a top view and a cross section side view along line A-A of parts of a mobile device configured to implement the method of FIG. 7.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a thermal solution for mobile device will now be presented with reference to various apparatus and methods. These apparatus and methods will be described in the following detailed description and illustrated in the accompanying drawings by various blocks, components, circuits, steps, processes, algorithms, etc. (collectively referred to as “elements”).

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

A mobile device may be a smart phone, a tablet computer, a smart watch, a head-mounted display, a portable media player, a personal navigation device, a wearable device, etc. A mobile device may also be referred to as a mobile station, a user equipment (UE), a subscriber station, a mobile unit, a subscriber unit, a wireless unit, a remote unit, a wireless device, a wireless communications device, a remote device, a mobile subscriber station, an access terminal, a mobile terminal, a wireless terminal, a remote terminal, a handset, a user agent, a mobile client, a client, or some other suitable terminology.

An electromagnetic interference (EMI) shield may be used to cover one or more electronic components of a mobile device to reduce the electromagnetic field with barriers made of conductive or magnetic material. The EMI shield may form an enclosure to isolate the electronic components from the ‘outside world’. The EMI shield can reduce the coupling of radio waves, electromagnetic fields and electrostatic fields.

A heat pipe is a heat-transfer device that combines the principles of both thermal conductivity and phase transition to efficiently manage the transfer of heat between two solid interfaces. At the hot interface of a heat pipe, a liquid in contact with a thermally conductive solid surface turns into a vapor by absorbing heat from that surface. The vapor then travels along the heat pipe to the cold interface and condenses back into a liquid, thus releasing the heat through the cold interface. The liquid then returns to the hot interface using a wick structure exerting a capillary action on the liquid phase of the fluid, and the cycle repeats. A heat pipe may be used in a mobile device as part of the thermal solution for the device.

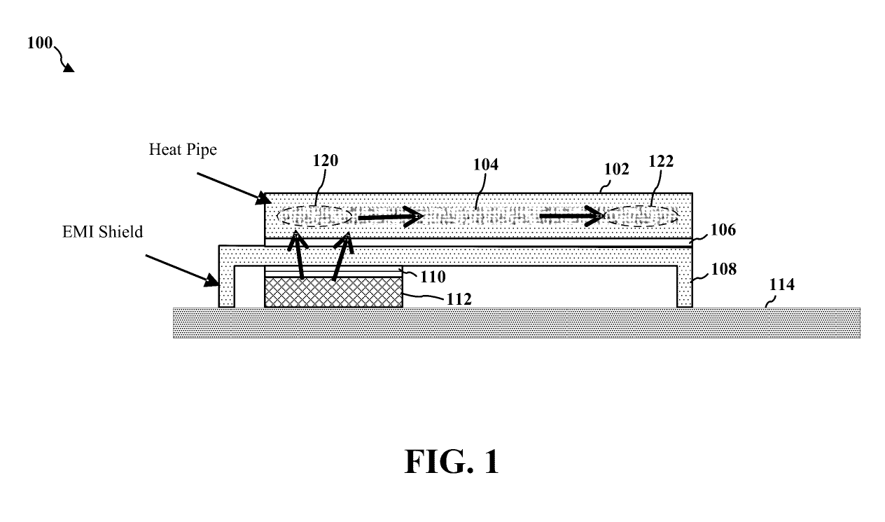

In one configuration, a heat pipe is placed over the EMI shield covering one or more electronic components to transfer the heat generated by the electronic components to a cold area of the mobile device, therefore improving thermal condition and performance of the mobile device. FIG. 1 is a diagram illustrating an example of a cross section side view of parts of a mobile device 100. As shown in the example, the mobile device 100 includes a heat pipe 102, an EMI shield 108, an IC 112, and a printed circuit board (PCB) 114. The heat pipe 102 may include a wick structure 104, a hot interface 120, and a cold interface 122.

The IC 112 may mount on top of the PCB 114 and is covered by the EMI shield 108, which reduces the electromagnetic field surrounding the IC 112. There is a thermal interface layer 110 between the IC 112 and an inner surface of the EMI shield 108. The heat pipe 102 is stacked on top of the EMI shield 108. There is a thermal interface layer 106 between the EMI shield 108 and the heat pipe 102. The thermal interface layers 106 and 110 are made of thermally conductive materials.

The IC 112 generates heat during the operation of the mobile device 100. A portion of the heat generated by the IC 112 may be transferred to the EMI shield 108 through the thermal interface layer 110. The heat transferred to the EMI shield 108 may be further transferred to the hot interface 120 of the heat pipe 102 through the thermal interface layer 106. At the hot interface 120 of the heat pipe 102, a liquid in contact with a thermally conductive solid surface turns into a vapor by absorbing heat from that surface. The vapor then travels along the heat pipe 102 to the cold interface 122 and condenses back into a liquid, thus releasing the heat through the cold interface 122. The liquid then returns to the hot interface 120 using the wick structure 104 exerting a capillary action on the liquid phase of the fluid, and the cycle repeats.

Because of the small form factor of the mobile device 100, the design bottleneck for a thermal solution for mobile device 100 is that stacking all components (e.g., the heat pipe 102, the EMI shield 108, and the thermal interface layer 106) increases the thickness of the mobile device 100. The existence of the thermal interface layer 106 between the heat pipe 102 and the EMI shield 108 also adds cost to the manufacture of the mobile device 100. Accordingly, a more form factor friendly thermal solution is desirable.

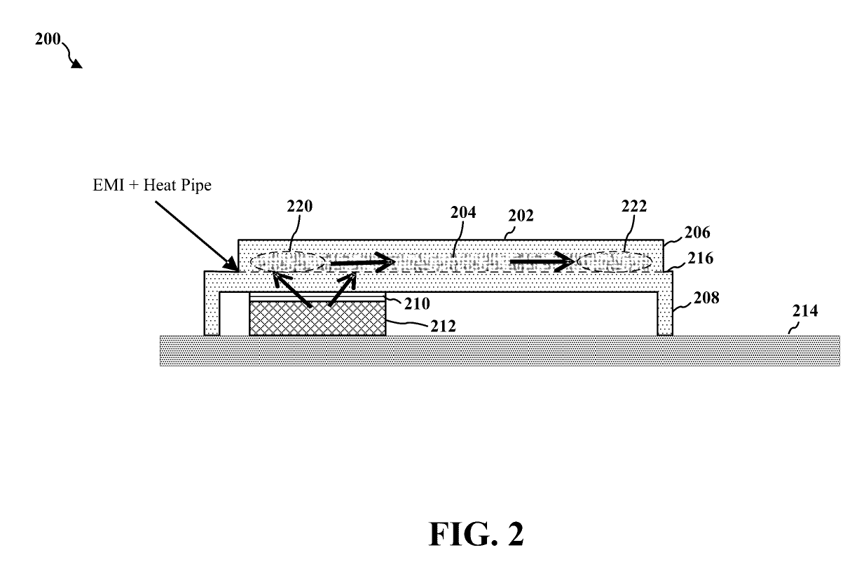

FIG. 2 is a diagram illustrating an example of a cross section side view of parts of a mobile device 200. The mobile device 200 includes a mechanism for spreading heat generated by a heat source of the mobile device 200 to regions of the mobile device 200 remote from the heat source. As shown in the example, the mobile device 200 includes a single-piece hybrid component 202, one or more electronic components (e.g., IC 212), and a PCB 214. The single-piece hybrid component 202 includes two parts: a heat pipe 206 and an EMI shield 208. The heat pipe 206 of the single-piece hybrid component 202 includes a wick structure 204, a hot interface 220, and a cold interface 222. There may be a thermal interface layer 210 between the IC 212 and an inner surface of the EMI shield 208.

One or more of the electronic components, such as IC 212, may perform a set of operations/functions that cause the electronic component to emit heat. In one configuration, the electronic components emit heat even though the set of operations/functions (e.g., computation and communication) performed by the electronic components is not for the purposes of generating heat. In other words, the heat generated by the electronic components is a byproduct of the component's intended operation/function. In one configuration, the IC 212 may be a SoC that integrates all components of a computer or other electronic system into a single chip. In another configuration, the IC 212 may be a SiP that includes a number of chips in a single package. In yet another configuration, the IC 212 may be a PoP stacking that combines vertically discrete logic and memory ball grid array (BGA) packages. In one configuration, the IC 212 includes at least one of a central processing unit (CPU), graphics processing unit (GPU), or wireless communication chip. In one configuration, the IC 212 may be mounted on the PCB 214. In one configuration, the one or more electronic components (e.g., the IC 212) may be enclosed within the EMI shield 208 of the single-piece hybrid component 202. The PCB 214 electrically connects electronic components using conductive tracks, pads and other features etched from copper sheets laminated onto a non-conductive substrate.

The EMI shield 208 of the single-piece hybrid component 202 covers the one or more electronic components (e.g., the IC 212) and reduces the electromagnetic field surrounding the electronic components. In one configuration, the EMI shield 208 may be made of one or more suitable thermally conductive materials, such as stainless steel, copper, nickel, titanium, or aluminum.

The heat pipe 206 of the single-piece hybrid component 202 transfers heat from the hot interface 220 to the cold interface 222. The heat pipe 206 may be long and thin. In one configuration, the thickness of the heat pipe 206 may be 0.3 to 1 mm or higher. The length of the heat pipe 206 can be as long as the design requires. In one configuration, the heat pipe 206 extends from the hot region (e.g., the region near the IC 212) to the cold region (e.g., the region that is at least a threshold distance away from main heat-emitting components, such as IC 212, of the mobile device 200). In one configuration, the heat pipe 206 may be a grooved heat pipe or a Thermal Ground Plate (TGP).

In one configuration, a portion of the heat generated by one or more electronic components (e.g., the IC 212) may be transferred to the EMI shield 208 of the single-piece hybrid component 202 through the thermal interface layer 210. The heat transferred to the EMI shield 208 may be further transferred to the hot interface 220 of the heat pipe 206. In one configuration, the hot interface 220 of the heat pipe 206 captures a portion of the heat emitted by the one or more electronic components (e.g., the IC 212). The captured heat is transferred to the cold interface 222 of the heat pipe 206, which is located at the cold region of the mobile device 200. In one configuration, at the hot interface 220 of the heat pipe 206, a liquid in contact with an inner surface of the casing of the heat pipe 206 turns into a vapor by absorbing heat from that surface. The vapor then travels along the heat pipe 206 to the cold interface 222 and condenses back into a liquid, thus releasing the heat through the cold interface 222. The liquid then returns to the hot interface 220 using the wick structure 204 exerting a capillary action on the liquid phase of the fluid, and the cycle repeats.

In one configuration, the heat pipe 206 and the EMI shield 208 are integral part of each other. In one configuration, at least one surface (e.g., surface 216) of the EMI shield 208 is configured to be a portion of the casing of the heat pipe 206. In such configuration, the wick structure 204 is in direct contact with the surface 216 of the EMI shield 208. In one configuration, the IC 212 may be within an IC package; and the single-piece hybrid component 202 may be outside the IC package that contains the IC 212.

Because the single-piece hybrid component 202 does not have a thermal interface layer (e.g., the thermal interface layer 106 described above with reference to FIG. 1) between the heat pipe 206 and the EMI shield 208, the thickness of the mobile device 200 is reduced comparing to the mobile device 100 described above with reference to FIG. 1. Because there is no thermal interface layer between the heat pipe 206 and the EMI shield 208, the heat transfer between the EMI shield 208 and the heat pipe 206 is more efficient, thus the mobile device 200 provides better thermal performance than the mobile device 100. Furthermore, because the surface 216 of the EMI shield 208 is shared by the heat pipe 206 as a portion of the casing of the heat pipe 206, the thickness of the heat pipe 206 is reduced, thus reducing the overall thickness of the mobile device 200.

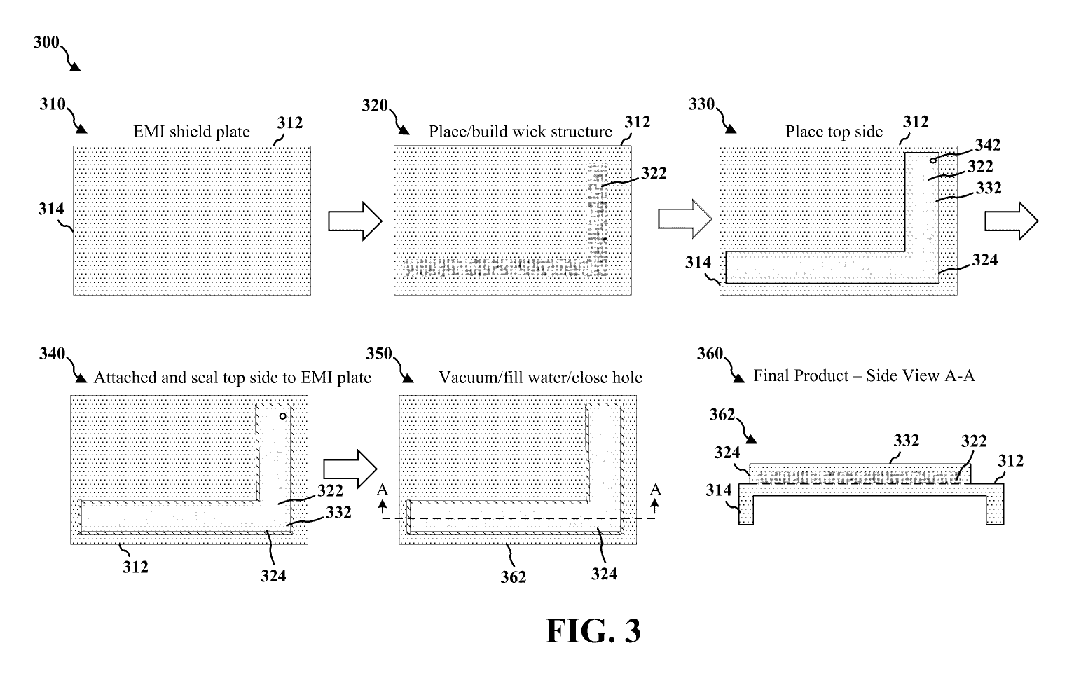

FIG. 3 is a diagram illustrating an example of a manufacturing process 300 for a single-piece hybrid component that integrates EMI shield and heat pipe. In one configuration, the single-piece hybrid component may be the single-piece hybrid component 202 described above with reference to FIG. 2. Specifically, this example shows five manufacturing stages 310, 320, 330, 340, and 350, and a side view 360 of the final product of the single-piece hybrid component 362.

At stage 310, a piece of EMI shield plate 312 for the EMI shield 314 is prepared. The EMI shield plate 312 may form, by itself or in combination with a PCB, an enclosure for one or more electronic components (e.g., the IC 212 described above with reference to FIG. 2). In one configuration, the EMI shield plate 312 may be made of one or more suitable thermally conductive materials, such as stainless steel, copper, nickel, titanium, or aluminum.

At stage 320, a wick structure 322 is placed or built over the EMI shield plate 312 using typical micro-electro-mechanical systems (MEMS) fabrication process. In one configuration, the wick structure 322 may be the wick structure 204 described above with reference to FIG. 2.

At stage 330, a piece of sheet metal (e.g., copper) is placed over the wick structure 322 as the top side casing 332 of the heat pipe 324. As a result, the wick structure 322 is sandwiched between the EMI shield plate 312 of the EMI shield 314 and the top side casing 332 of the heat pipe 324. The top side casing 332 may contain an open hole 342.

At stage 340, the top side casing 332 is attached and sealed to the EMI shield plate 312, e.g., through soldering. As a result, the wick structure 322 is enclosed within a heat pipe casing formed by the top side casing 332 and the EMI shield plate 312. The EMI shield plate 312 acts as the bottom side casing of the heat pipe 324. Therefore, the EMI shield plate 312 of the EMI shield 314 is an integral part of the heat pipe 324.

Finally, at stage 350, the heat pipe 324 is vacuumed using the hole 342, working fluid (e.g., water) is filled into the heat pipe 324 through the hole 342, and the hole 342 is closed. The final product of the single-piece hybrid component 362 is produced.

The side view 360 along line A-A of the final product shows the single-piece hybrid component 362 includes two parts: the heat pipe 324 and the EMI shield 314. The heat pipe 324 contains the wick structure 322 that is sandwiched between the top side casing 332 and the EMI shield plate 312, which acts as the bottom side casing of the heat pipe 324.

A vapor chamber is a flat heat pipe that has the same primary components (e.g., a sealed casing, a working fluid, and a wick structure) as a tubular heat pipe. Compared to a one-dimensional tubular heat pipe, the width of a two-dimensional vapor chamber allows an adequate cross section for heat flow even with a very thin device. Therefore, vapor chambers are often used in mobile devices that have tight restriction on the thickness of the devices.

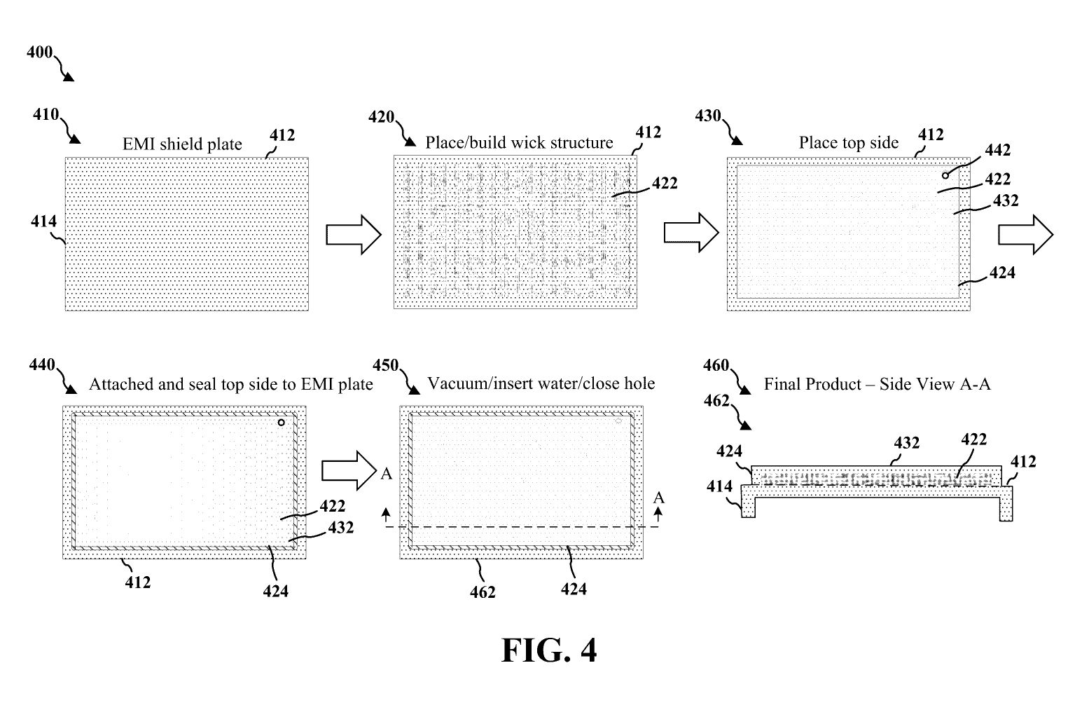

FIG. 4 is a diagram illustrating an example of a manufacturing process 400 for a single-piece hybrid component that integrates EMI shield and vapor chamber. In one configuration, the single-piece hybrid component may be the single-piece hybrid component 202 described above with reference to FIG. 2. Specifically, this example shows five manufacturing stages 410, 420, 430, 440, and 450, and a side view 460 of the final product of the single-piece hybrid component 462.

At stage 410, a piece of EMI shield plate 412 for the EMI shield 414 is prepared. The EMI shield plate 412 may form, by itself or in combination with a PCB, an enclosure for one or more electronic components (e.g., the IC 212 described above with reference to FIG. 2). In one configuration, the EMI shield plate 412 may be made of one or more suitable thermally conductive materials, such as stainless steel, copper, nickel, titanium, or aluminum.

At stage 420, a wick structure 422 is placed or built over the EMI shield plate 412 using typical MEMS fabrication process. In one configuration, the wick structure 422 may be the wick structure 204 described above with reference to FIG. 2.

At stage 430, a piece of sheet metal (e.g., copper) is placed over the wick structure 422 as the top side casing 432 of the vapor chamber 424. In one configuration, the top side casing 432 is configured to be the base of the vapor chamber 424. As a result, the wick structure 422 is sandwiched between the EMI shield plate 412 of the EMI shield 414 and the top side casing 432 of the vapor chamber 424. The top side casing 432 may contain an open hole 442. In one configuration, the wick structure 422, as well as the vapor chamber 424, occupies an entire surface of the EMI shield plate 412. In another configuration, the wick structure 422, as well as the vapor chamber 424, occupies a large area (e.g., more than half of the area) of a surface of the EMI shield plate 412.

At stage 440, the top side casing 432 is attached and sealed to the EMI shield plate 412, e.g., through soldering. As a result, the wick structure 422 is enclosed within a heat pipe casing formed by the top side casing 432 and the EMI shield plate 412. The EMI shield plate 412 acts as the bottom side casing of the vapor chamber 424. Therefore, the EMI shield plate 412 of the EMI shield 414 is an integral part of the vapor chamber 424.

Finally, at stage 450, the vapor chamber 424 of the single-piece hybrid component is vacuumed using the hole 442, working fluid (e.g., water) is filled into the vapor chamber 424 through the hole 442, and the hole 442 is closed. The final product of the single-piece hybrid component 462 is produced.

The side view 460 along line A-A of the final product shows the single-piece hybrid component 462 includes two parts: the vapor chamber 424 and the EMI shield 414. The vapor chamber 424 contains the wick structure 422 that is sandwiched between the top side casing 432 and the EMI shield plate 412, which acts as the bottom side casing of the vapor chamber 424.

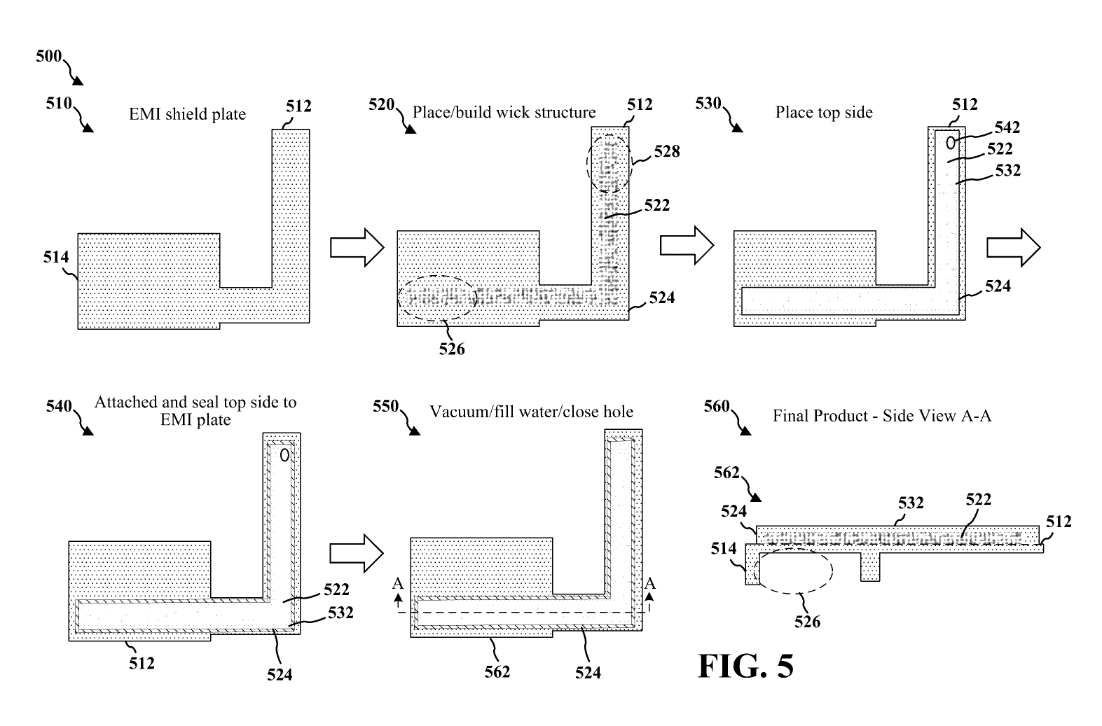

FIG. 5 is a diagram illustrating an example of a manufacturing process 500 for a single-piece hybrid component of a mobile device that transfers heat from a hot region of the mobile device to a cold region of the mobile device. In one configuration, the single-piece hybrid component may be the single-piece hybrid component 202 described above with reference to FIG. 2. Specifically, this example shows five manufacturing stages 510, 520, 530, 540, and 550, and a side view 560 of the final product of the single-piece hybrid component 562.

At stage 510, a piece of EMI shield plate 512 for the EMI shield 514 is prepared. The EMI shield plate 512 may form, by itself or in combination with a PCB, an enclosure for one or more electronic components (e.g., the IC 212 described above with reference to FIG. 2). In one configuration, the EMI shield plate 512 may be made of one or more suitable thermally conductive materials, such as stainless steel, copper, nickel, titanium, or aluminum.

At stage 520, a wick structure 522 for the heat pipe 524 is placed or built over the EMI shield plate 512 using typical MEMS fabrication process. In one configuration, the wick structure 522 may be the wick structure 204 described above with reference to FIG. 2. One end of the heat pipe 524 may be located at a hot region 526 of the mobile device, and the other end of the heat pipe 524 may be located at a cold region 528 of the mobile device. In one configuration, the hot region 526 may be within or near the enclosure formed by the EMI shield 514, and the cold region 528 may be outside the enclosure formed by the EMI shield 514.

At stage 530, a piece of sheet metal (e.g., copper) is placed over the wick structure 522 as the top side casing 532 of the heat pipe 524. As a result, the wick structure 522 is sandwiched between the EMI shield plate 512 of the EMI shield 514 and the top side casing 532 of the heat pipe 524. The top side casing 532 may contain an open hole 542.

At stage 540, the top side casing 532 is attached and sealed to the EMI shield plate 512, e.g., through soldering. As a result, the wick structure 522 is enclosed within a heat pipe casing formed by the top side casing 532 and the EMI shield plate 512. The EMI shield plate 512 acts as the bottom side casing of the heat pipe 524. Therefore, the EMI shield plate 512 of the EMI shield 514 is an integral part of the heat pipe 524.

Finally, at stage 550, the heat pipe 524 of the single-piece hybrid component is vacuumed using the hole 542, working fluid (e.g., water) is filled into the heat pipe 524 through the hole 542, and the hole 542 is closed. The final product of the single-piece hybrid component 562 is produced.

The side view 560 along line A-A of the final product shows the single-piece hybrid component 562 includes two parts: the heat pipe 524 and the EMI shield 514. The heat pipe 524 contains the wick structure 522 that is sandwiched between the top side casing 532 and the EMI shield plate 512, which acts as the bottom side casing of the heat pipe 524. One end of the heat pipe 524 is located at or near the hot region 526 of the mobile device.

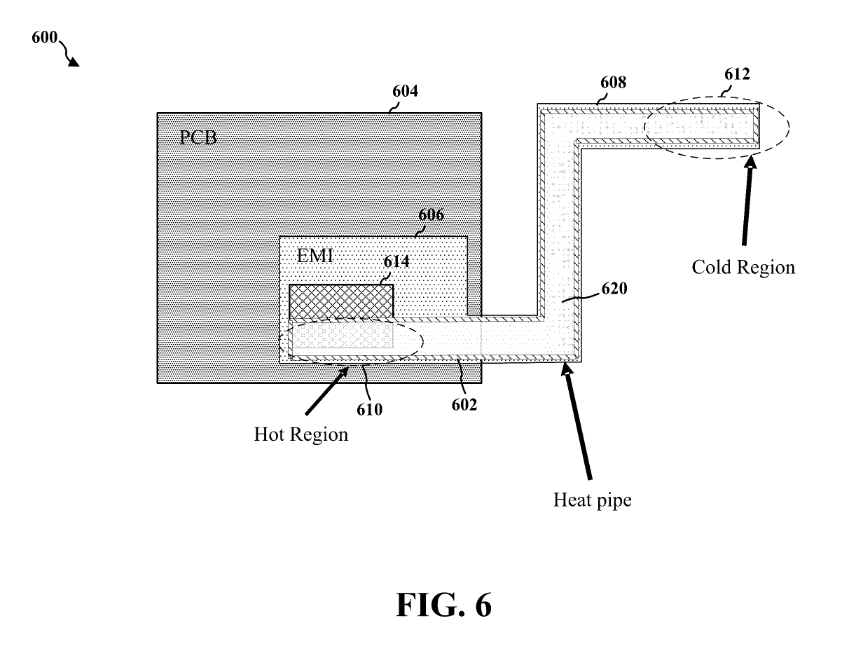

FIG. 6 is a diagram illustrating an example of a top view of parts of a mobile device 600 that includes a single-piece hybrid component 602. In one configuration, the mobile device may be the mobile device 200 described above with reference to FIG. 2. In one configuration, the single-piece hybrid component 602 may be the single-piece hybrid component 562 described above with reference to FIG. 5. The single-piece hybrid component 602 includes a mechanism for spreading heat generated by a heat source of the mobile device 600 to regions of the mobile device 600 that are remote from the heat source. As shown in the example, the single-piece hybrid component 602 may be mounted on top of a PCB 604. The single-piece hybrid component 602 includes two parts: a heat pipe 608 and an EMI shield 606. The heat pipe 608 includes a wick structure 620.

The heat pipe 608 of the single-piece hybrid component 602 transfers heat from a hot region 610 of the mobile device 600 to a cold region 612 of the mobile device 600. The heat pipe 608 may be long and thin. The length of the heat pipe 608 can be as long as the design requires. In one configuration, the EMI shield 606 of the single-piece hybrid component 602 may form, by itself or in combination with the PCB 604, an enclosure that encloses one or more electronic components (e.g., IC 614), which may emit heat during the operation of the mobile device 600. In such configuration, the hot region 610 may be within or near the enclosure formed by the EMI shield 606; and the cold region 612 may be outside the enclosure formed by the EMI shield 606. In one configuration, the IC 614 may be within an IC package; and the single-piece hybrid component 602 may be outside the IC package that contains the IC 614.

In one configuration, a portion of the heat generated by one or more electronic components (e.g., the IC 614) may be transferred to the EMI shield 606 of the single-piece hybrid component 602. The heat transferred to the EMI shield 606 may be further transferred to one end of the heat pipe 608 that is located at the hot region 610. In one configuration, the heat pipe 608 captures a portion of the heat received at the hot region 610. The heat pipe 608 transfers the captured heat to the cold region 612. In one configuration, at the hot region 610, a working liquid in contact with an inner surface of the casing of the heat pipe 608 turns into a vapor by absorbing heat from that surface. The vapor then travels along the heat pipe 608 to the cold region 612 and condenses back into a liquid, thus releasing the heat at the cold region 612. The working liquid then returns to the hot region 610 using the wick structure 620 of the heat pipe 608, and the cycle repeats.

In one configuration, the heat pipe 608 and the EMI shield 606 are integral part of each other. In one configuration, at least one surface of the EMI shield 606 is configured to be a portion of the casing of the heat pipe 608. In such configuration, the wick structure 620 is in direct contact with the surface of the EMI shield 606.

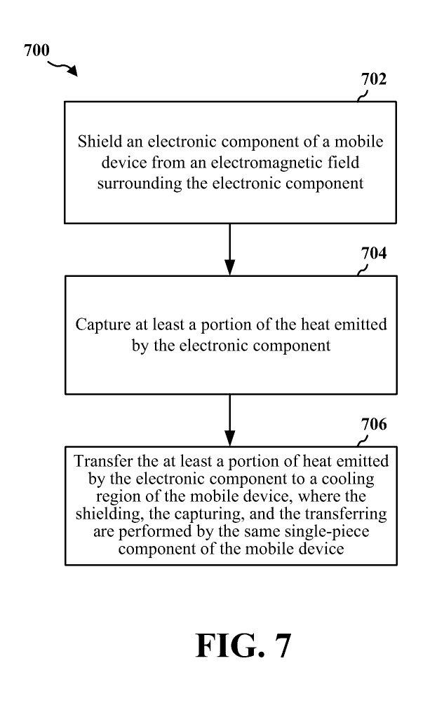

FIG. 7 is a flowchart 700 of a method of providing a thermal solution for a mobile device. The method may be performed by a mobile device (e.g., the mobile device 200 or 800). In one configuration, the method begins when the mobile device is turned on.

At 702, the mobile device shields an electronic component of the mobile device from an electromagnetic field surrounding the electronic component. In one configuration, the electronic component may be a SoC that integrates all components of a computer or other electronic system into a single chip. In another configuration, the electronic component may be a SiP that includes a number of chips in a single package. In yet another configuration, the electronic component may be a PoP stacking that combines vertically discrete logic and memory BGA packages. In one configuration, the electronic component may include at least one of a CPU, GPU, or wireless communication chip. In one configuration, the electronic component may be the IC 212 described above with reference to FIG. 2. In one configuration, the operations at 702 may be performed by the EMI shield (e.g., 208, 314, 414, 514, or 606) of a single-piece hybrid component. In such configuration, the EMI shield may forms an enclosure that encloses the electronic component.

At 704, the mobile device captures at least a portion of the heat emitted by the electronic component. In one configuration, the operations at 704 may be performed by the EMI shield of the single-piece hybrid component. In one configuration, heat emitted by the electronic component may be captured by the EMI shield through direct contact between the electronic component and the EMI shield. In another configuration, heat emitted by the electronic component may be captured by the EMI shield through indirect contact between the electronic component and the EMI shield. For example, the heat may be transferred from the electronic component to the EMI shield through a thermal interface layer (e.g., the thermal interface layer 210 describe above with reference to FIG. 2). In one configuration, the EMI shield of the single-piece hybrid component may be made of thermally conductive materials, so that the captured heat may be transferred to the heat pipe of the single-piece hybrid component.

At 706, the mobile device transfers the at least a portion of heat emitted by the electronic component to a cooling region of the mobile device. The shielding, the capturing, and the transferring may be performed by the same single-piece hybrid component (e.g., 202, 362, 462, 562, 602, or 802) of the mobile device. In one configuration, the operations at 706 may be performed by the heat pipe (e.g., 206, 324, 424, 524, or 608) of the single-piece hybrid component. In one configuration, one end of the heat pipe receives the heat emitted by the electronic component through the EMI shield at a hot region of the mobile device. In such configuration, the heat pipe transfers some of the received heat to the other end of the heat pipe, which is located at the cooling region of the mobile device. The cooling region has lower temperature than the electronic component and the hot region. In one configuration, the cooling region of the mobile device is located outside of the enclosure formed by the EMI shield. In one configuration, the cooling region is located at least a threshold distance away from main heat-emitting components of the mobile device.

In one configuration, the EMI shield and the heat pipe are integral part of each other. In one configuration, at least one surface of the EMI shield is configured to be a portion of the casing of the heat pipe. In such configuration, the wick structure of the heat pipe may be in direct contact with the at least one surface of the EMI shield, and the wick structure is sandwiched between the at least one surface of the EMI shield and a metal plate that is configured to be a portion of the casing of the heat pipe. In one configuration, the heat pipe may be a vapor chamber. In such configuration, the metal plate that is configured to be a portion of the casing of the heat pipe may serve as the base of the vapor chamber.

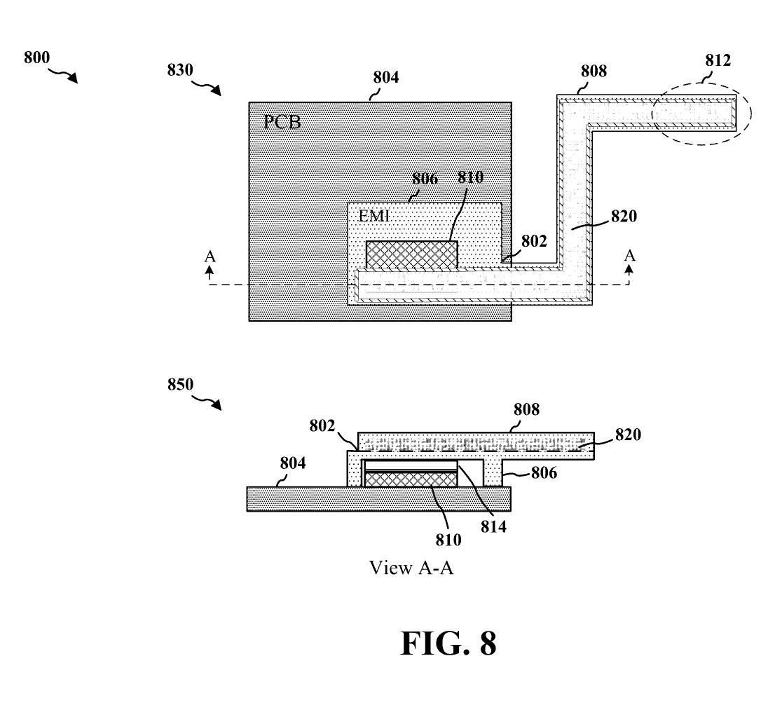

FIG. 8 is a diagram illustrating a top view 830 and a cross section side view 850 along line A-A of parts of a mobile device 800 configured to implement the method of FIG. 7. In one configuration, each component of the mobile device 800 performs similar functions to the corresponding component of mobile device 200 or 600 described above with reference to FIG. 2 or FIG. 6, respectively. The mobile device 800 includes a single-piece hybrid component 802. As shown, the single-piece hybrid component 802 may be mounted on top of a PCB 804.

The mobile device 800 may include means for shielding an electronic component of the mobile device from an electromagnetic field surrounding the electronic component. In one configuration, the means for shielding may be the EMI shield 806 of the single-piece hybrid component 802. In one configuration, the means for shielding may be configured to form, by itself or in combination with the PCB 604, an enclosure that encloses the electronic component (e.g., IC 810), which may emit heat during the operation of the mobile device 800. In one configuration, the IC 810 may be within an IC package; and the single-piece hybrid component 802 may be outside the IC package that contains the IC 810. In one configuration, the means for shielding performs the operations described above with reference to 702 of FIG. 7.

The mobile device 800 may include means for capturing at least a portion of the heat emitted by the electronic component. In one configuration, the means for capturing may be the EMI shield 806 of the single-piece hybrid component 802. In one configuration, the means for capturing may be configured to contact the electronic component directly or indirectly (e.g., through a thermal interface layer 814). In one configuration, the means for capturing performs the operations described above with reference to 704 of FIG. 7.

The mobile device 800 may include means for transferring the at least a portion of heat emitted by the electronic component to a cooling region 812 of the mobile device 800. In one configuration, the means for transferring may be the heat pipe 808 of the single-piece hybrid component 802. The means for transferring may include a wick structure 820. In one configuration, the means for transferring performs the operations described above with reference to 706 of FIG. 7.

In one configuration, the means for shielding, capturing, and transferring are different parts of the single-piece hybrid component 802. In one configuration, the means for shielding, capturing, and transferring are integral part of each other. In one configuration, at least one surface of the means for shielding is configured to be a portion of the casing of the means for transferring. In such configuration, the wick structure 820 of the means for transferring is in direct contact with the surface of the means for shielding.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus, comprising:
an electronic component that emits heat during an operation of the apparatus; and
a single-piece component covering the electronic component, the single-piece component configured to:
shield the electronic component from an electromagnetic field surrounding the electronic component; and
transfer at least a portion of the heat emitted by the electronic component to a cooling region of the apparatus.

2. The apparatus of claim 1, wherein the single-piece component comprises an electromagnetic interference (EMI) shield and a heat pipe, wherein the EMI shield and the heat pipe are integral part of each other.

3. The apparatus of claim 2, wherein at least one surface of the EMI shield is configured to be a portion of a casing of the heat pipe.

4. The apparatus of claim 3, wherein the heat pipe comprises a wick structure that is in direct contact with the at least one surface of the EMI shield.

5. The apparatus of claim 4, wherein the wick structure is sandwiched between the at least one surface of the EMI shield and a metal plate.

6. The apparatus of claim 5, wherein the heat pipe is a vapor chamber, wherein the metal plate is configured to be a base of the vapor chamber.

7. The apparatus of claim 4, wherein the wick structure extends to the cooling region of the apparatus.

8. The apparatus of claim 2, wherein the EMI shield comprises a thermally conductive material.

9. The apparatus of claim 1, wherein the single-piece component forms an enclosure to cover the electronic component, wherein the cooling region of the apparatus is outside the enclosure of the single-piece component and has lower temperature than the electronic component.

10. The apparatus of claim 1, wherein the electronic component comprises one of: a system on chip (SOC), a central processing unit (CPU), a graphics processing unit (GPU), or a wireless communication chip.

11. A method for a mobile device, comprising:
shielding an electronic component of the mobile device from an electromagnetic field surrounding the electronic component; and
transferring at least a portion of heat emitted by the electronic component to a cooling region of the mobile device,
wherein the shielding and the transferring are performed by a same single-piece component.

12. The method of claim 11, further comprising capturing the at least a portion of the heat emitted by the electronic component, wherein the capturing is performed by the same single-piece component.

13. The method of claim 11, wherein the shielding is performed by an electromagnetic interference (EMI) shield of the single-piece component and the transferring is performed by a heat pipe of the single-piece component, wherein the EMI shield and the heat pipe are integral part of each other.

14. The method of claim 13, wherein at least one surface of the EMI shield is configured to be a portion of a casing of the heat pipe.

15. The method of claim 14, wherein the heat pipe comprises a wick structure that is in direct contact with the at least one surface of the EMI shield.

16. The method of claim 15, wherein the wick structure is sandwiched between the at least one surface of the EMI shield and a metal plate.

17. The method of claim 16, wherein the heat pipe is a vapor chamber, wherein the metal plate is configured to be a base of the vapor chamber.

18. The method of claim 15, wherein the wick structure extends to the cooling region of the mobile device.

19. The method of claim 13, wherein the EMI shield comprises a thermally conductive material.

20. The method of claim 11, wherein the single-piece component forms an enclosure to enclose the electronic component, wherein the cooling region of the mobile device is outside the enclosure of the single-piece component and has lower temperature than the electronic component.

21. The method of claim 11, wherein the electronic component comprises one of: a system on chip (SOC), a central processing unit (CPU), a graphics processing unit (GPU), or a wireless communication chip.

22. An apparatus, comprising:
means for shielding an electronic component of the apparatus from an electromagnetic field surrounding the electronic component; and
means for transferring at least a portion of heat emitted by the electronic component to a cooling region of the apparatus,
wherein the means for shielding and the means for transferring are different parts of a single-piece component.

23. The apparatus of claim 22, further comprising means for capturing the at least a portion of the heat emitted by the electronic component, wherein the means for capturing is a part of the single-piece component.

24. The apparatus of claim 22, wherein the means for shielding is an electromagnetic interference (EMI) shield of the single-piece component and the means for transferring is a heat pipe of the single-piece component, wherein the EMI shield and the heat pipe are integral part of each other.

25. The apparatus of claim 24, wherein at least one surface of the EMI shield is configured to be a portion of a casing of the heat pipe.

26. The apparatus of claim 25, wherein the heat pipe comprises a wick structure that is in direct contact with the at least one surface of the EMI shield.

27. The apparatus of claim 26, wherein the wick structure is sandwiched between the at least one surface of the EMI shield and a metal plate.

28. The apparatus of claim 27, wherein the heat pipe is a vapor chamber, wherein the metal plate is configured to be a base of the vapor chamber.

29. The apparatus of claim 26, wherein the wick structure extends to the cooling region of the apparatus.

30. The apparatus of claim 24, wherein the EMI shield comprises a thermally conductive material.
